(19) United States
(12) Patent Application Publication
(10) Pub. No.: US 2026/0094474 A1
(43) Pub. Date: Apr. 2, 2026

(54) SYSTEM AND METHODS FOR PREDICTIVE VEHICLE MAINTENANCE

(71) Applicant: State Farm Mutual Automobile Insurance Company, Bloomington, IL (US)

(72) Inventor: Ryan Michael GROSS, Normal, IL (US)

(73) Assignee: State Farm Mutual Automobile Insurance Company, Bloomington, IL (US)

(21) Appl. No.: 18/917,319

(22) Filed: Oct. 16, 2024

Related U.S. Application Data
(60) Provisional application No. 63/701,750, filed on Oct. 1, 2024.

(51) Int. Cl. G07C 5/00

(52) U.S. Cl. CPC G07C 5/006; G07C 5/004

(57) ABSTRACT

Systems and methods for monitoring the operational condition of target vehicles for predicting an inoperability period to activate system-based actions are disclosed. The computer-implemented method may include, such as by one or more processors, transceivers, and/or sensors: (1) receiving telematics or historical data associated with the target vehicles; (2) processing the telematics or historical data to derive a plurality of features; (3) inputting the plurality of features into a trained machine-learning model configured to determine the operational condition of the target vehicles and predict the inoperability period for the target vehicles; (4) receiving a predicted inoperability period for the target vehicles from the trained machine-learning model; (5) automatically executing the system-based actions based upon the predicted inoperability period; (6) determining recommended actions based upon the operational condition of the target vehicles; and/or (7) outputting notifications on a user interface of devices associated with users of the target vehicles.

### CROSS-REFERENCE TO RELATED APPLICATION

This patent application claims the benefit of priority to U.S. Provisional Application No. 63/701,750, filed on October 1, 2024, the entirety of which is incorporated herein by reference.

### TECHNICAL FIELD

This present disclosure relates generally to the field of data processing and predictive vehicle analytics. In particular, the present disclosure relates to analyzing vehicle telematics data for monitoring the vehicle’s operational condition to predict inoperability periods of the vehicle in order to activate system-based actions.

### BACKGROUND

Conventional methods for processing vehicle sensor data may rely on static, rule-based systems that analyze limited parameters, such as engine temperature, fuel levels, or speed. Conventional solutions may be technically challenged to handle the vast amount of real-time sensor data generated by modern vehicles, leading to latency and inefficiency in data handling. For example, conventional solutions may be reactive rather than proactive, identifying issues after performance degradation has occurred, as such solutions are technically unequipped to leverage real-time sensor data to predict potential vehicle failures.

Additionally, conventional systems may be technically inept in integrating advanced analytics, resulting in preventing predictive insights that could ward off vehicle breakdowns. Such absence of predictive capabilities and real-time adaptability may hinder the ability of conventional techniques to maintain the optimal vehicle performance and prevent unexpected failures. Conventional methods may further include additional ineffectiveness, encumbrances, inefficiencies, and other drawbacks, as well.

### SUMMARY

The present embodiments may relate, inter alia, to solving one or more technical challenges, such as those discussed herein, and may leverage real-time sensor data to predict a vehicle inoperability period, as well as automatically activate system-based actions for coverage against potential repair costs and downtime.

Specifically, the present computer systems and computer-implemented methods may solve technical challenges by leveraging data (e.g., sensor data, real-time, and/or historical data) and advanced predictive analytics (e.g.,via a trained machine-learning model) to accurately predict a vehicle’s inoperability period. Once a failure prediction is triggered, the system may automatically activate system-based actions that provides assistance for various services (e.g., towing, repair, or rental) and the downtime associated with the vehicle’s inoperability.

In one aspect, a computer-implemented method for monitoring an operational condition of one or more target vehicles for predicting an inoperability period to activate one or more system-based actions may be provided. The computer-implemented method may be implemented via one or more local or remote processors, servers, transceivers, sensors, memory units, mobile devices, smart watches, smart contact lenses, smart glasses, smart vehicles, augmented reality glasses, virtual reality headsets, mixed or extended reality glasses or headsets, voice bots or chatbots, ChatGPT bots, InstructGPT bots, Codex bots, Google Bard bots, and/or other electronic or electrical components, which may be in wired or wireless communication with one another. In one instance, the computer-implemented method may be performed by one or more local or remote processors of a computing system in communication with one or more local or remote data sources. The computer-implemented method may include, via one or more processors, transceivers, sensors, and/or other components: (1) receiving, by the one or more processors, telematics data and/or historical data associated with the one or more target vehicles; (2) processing, by the one or more processors, the telematics data and/or the historical data associated with the one or more target vehicles to derive a plurality of features; (3) inputting, by the one or more processors, the plurality of features into a trained machine-learning model configured to determine the operational condition of the one or more target vehicles and predict the inoperability period for the one or more target vehicles; (4) receiving, by the one or more processors, a predicted inoperability period for the one or more target vehicles from the trained machine-learning model; (5) automatically executing, by the one or more processors, one or more system-based actions based upon the predicted inoperability period; (6) determining, by the one or more processors, one or more recommended actions based upon the operational condition of the one or more target vehicles; and/or (7) outputting, by the one or more processors, one or more notifications (such as recommended actions and an indicator corresponding to the one or more system-based actions) on a user interface of one or more devices associated with one or more users of the one or more target vehicles. The method may include additional, less, or alternate functionality, including that discussed elsewhere herein.

In another aspect, a computer-implemented or computer-based method for activating a coverage policy for one or more target vehicles based upon telematics data may be provided. The computer-implemented method may be implemented via one or more local or remote processors, servers, transceivers, sensors, memory units, mobile devices, smart watches, smart contact lenses, smart glasses, smart vehicles, augmented reality glasses, virtual reality headsets, mixed or extended reality glasses or headsets, voice bots or chatbots, ChatGPT bots, InstructGPT bots, Codex bots, Google Bard bots, and/or other electronic or electrical components, which may be in wired or wireless communication with one another. In one instance, the computer-implemented method may be performed by one or more local or remote processors of a computing system in communication with one or more local or remote data sources. The computer-implemented method may include, via one or more processors, transceivers, sensors, and/or other components: (1) receiving, in real-time by the one or more processors, the telematics data from one or more sensors associated with the one or more target vehicles; (2) processing, by the one or more processors, the telematics data to derive a plurality of features; (3) inputting, by the one or more processors, the plurality of features into a trained machine-learning model configured to identify one or more mechanical issue patterns corresponding to one or more mechanical issues; (4) receiving, by the one or more processors, the one or more mechanical issues from the trained machine-learning model; (5) determining, by the one or more processors, whether the one or more mechanical issues exceeds a severity threshold; (6) in response to determining that the one or more mechanical issues exceeds the severity threshold, activating, by the one or more processors, the coverage policy for the one or more target vehicles; and/or (7) outputting, by the one or more processors, one or more notifications (such as coverage policy and one or more recommended actions) on a user interface of one or more devices associated with one or more users of the one or more target vehicles. The method may include additional, less, or alternate functionality, including that discussed elsewhere herein.

In yet another aspect, a computer system for monitoring an operational condition of one or more target vehicles for predicting an inoperability period to activate a coverage policy may be provided. The system may be implemented via one or more local or remote processors, servers, transceivers, sensors, memory units, mobile devices, smart watches, smart contact lenses, smart glasses, smart vehicles, augmented reality glasses, virtual reality headsets, mixed or extended reality glasses or headsets, voice bots or chatbots, ChatGPT bots, InstructGPT bots, Codex bots, Google Bard bots, and/or other electronic or electrical components, which may be in wired or wireless communication with one another. In one instance, the system may be performed by one or more local or remote processors of a computing system in communication with one or more local or remote data sources, and at least one non-transitory computer readable medium storing instructions which, when executed by the one or more processors, cause the one or more processors to perform certain operations. The system may include, via one or more processors, non-transitory computer readable medium, transceivers, sensors, and/or other components: (1) receiving telematics data or historical data associated with the one or more target vehicles, wherein the telematics data includes one or more of engine diagnostics data, sensor data, or performance data, and wherein the historical data includes one or more of past claims data, past repair and maintenance data, or model-specific performance data; (2) processing the telematics data or the historical data associated with the one or more target vehicles to derive a plurality of features; (3) inputting the plurality of features into a trained machine-learning model configured to determine the operational condition of the one or more target vehicles and predict the inoperability period for the one or more target vehicles; (4) receiving a predicted inoperability period for the one or more target vehicles from the trained machine-learning model; (5) activating the coverage policy for the one or more target vehicles during the predicted inoperability period; (6) determining one or more recommended actions based upon the operational condition of the one or more target vehicles; and/or (7) outputting one or more notifications on a user interface of one or more devices associated with one or more users of the one or more target vehicles, wherein the one or more notifications includes the one or more recommended actions and an indicator corresponding to the activated coverage policy. The method may include additional, less, or alternate functionality, including that discussed elsewhere herein.

### BRIEF DESCRIPTION OF THE DRAWINGS

The figures described below depict various aspects of the system and methods disclosed herein. It should be understood that each figure depicts an embodiment of a particular aspect of the disclosed system and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a diagram showing an exemplary computer system and/or computing environment for leveraging real-time vehicle telematics data to predict mechanical issues to automatically trigger a coverage policy during the vehicle’s inoperability period, according to certain aspects of the disclosure.

FIG. 2 is a flowchart of an exemplary computer-implemented or computer-based process implementable by the computer system of FIG. 1 for analyzing various data utilizing a trained machine-learning model to determine an inoperability period for a vehicle and activate a coverage policy for the predicted inoperability period, according to certain aspects of the disclosure.

FIG. 3 is a flowchart of an exemplary computer-implemented or computer-based process implementable by the computer system of FIG. 1 for activating a coverage policy for one or more target vehicles based upon telematics data, according to certain aspects of the disclosure.

FIG. 4 shows an exemplary machine-learning training flow chart.

FIG. 5 illustrates an implementation of an exemplary computer system that executes techniques presented herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### DETAILED DESCRIPTION

The present embodiments may relate, inter alia, to computer systems and computer-implemented methods that solve technical challenges by leveraging data (e.g., sensor data, real-time, and/or historical data) and advanced predictive analytics to accurately forecast a vehicle’s inoperability period. By continuously analyzing high-frequency, multi-dimensional data streams, the system may employ machine-learning algorithms to detect subtle patterns indicative of mechanical degradation. These models may dynamically adapt to real-time conditions, enabling the system to predict failures well before such failures occur. Once a failure prediction is triggered, the system may automatically activate a policy (e.g., an insurance policy), which may cover both the repair cost and the downtime associated with the vehicle’s inoperability. Such integration of predictive maintenance and real-time policy activation may ensure timely interventions and improve the operational efficiency of the vehicle.

By way of background information, modern vehicles are equipped with a wide range of sensors collecting real-time data on various operational parameters (e.g., telematics, engine performance, fuel efficiency). Conventional methods often lack the computational power and/or sophisticated data-handling capabilities to efficiently process and analyze such a continuous influx of sensor data. These methods typically utilize fixed, rule-based systems that cannot manage multi-dimensional data in real-time, leading to information loss or delays in identifying performance issues. Additionally, the sheer volume and complexity of the data may overwhelm conventional data processing pipelines, leading to delays in detecting critical vehicle conditions.

Additionally, conventional systems may lack the integrated architecture and data harmonization capabilities needed to combine and process sensor data. The lack of standardization and efficient data fusion techniques may limit the capability of a conventional system to scale across different vehicle models, which may lead to inefficiencies and potential information gaps. Conventional techniques may also lack the capability to integrate advanced computational techniques, such as machine-learning, for detecting complex patterns, correlations, and anomalies in large datasets. Such an absence of machine-learning models may prevent early detection of vehicle wear and tear or abnormal vehicle operational patterns, often leading to a failure to intervene before critical problems arise.

As a result, there is a need for advanced data-driven models, methods, and tools for processing sensor data and other vehicle-related data (e.g.,via a trained machine-learning model) to detect early signs of mechanical issues, predict an inoperability period for the vehicle, and automatically activate a policy that provides assistance for repairs, rental, and towing services.

### EXEMPLARY COMPUTER SYSTEM

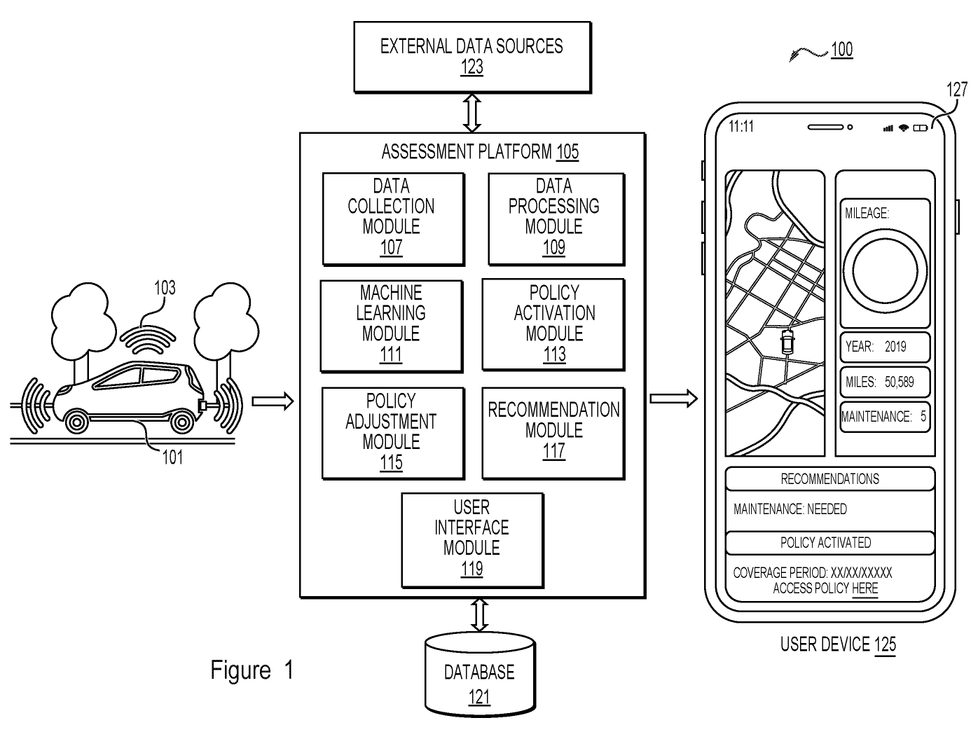

To address technical challenges such as the above, system 100 of FIG. 1 improves the state of conventional technologies by implementing advanced data processing and computing capabilities into computer-implemented methods and computer systems for processing real-time telematics data and/or historical data associated with one or more vehicles, in order to predict mechanical issues for activating a coverage policy and generating recommendations. In one instance, the system 100 may utilize a machine-learning model trained on historical data to learn associations between the data, such as patterns and trends that may indicate mechanical issues, and make accurate predictions based upon the likelihood of the occurrence of such mechanical issues and the current data (e.g.,real-time data) that is input into to the machine-learning models.

By leveraging real-time telematics data from various vehicle sensors, the system 100 may provide a proactive solution to vehicle maintenance, allowing mechanical issues to be detected and addressed before they lead to significant failures. The use of machine-learning may enable the system 100 to predict the inoperability period of the vehicle with high accuracy, based upon patterns in sensor data, engine diagnostics, and historical repair information. This may reduce vehicle downtime and may allow coverage policies to be activated when necessary, offering seamless protection without manual intervention. Additionally, the system 100 may dynamically adjust the coverage policy if repairs take longer than expected. The system 100 may monitor, in real-time, the progression of repairs for the vehicles, and may extend the coverage policy if the repair completion exceeds the predicted inoperability period.

In one instance, the system 100 may provide immediate recommendations for towing, repairs, and renal services, ensuring that users are given the best possible options based upon proximity, cost, and service quality. For example, the system 100 may synchronize data from towing, repairs, and renal services to provide optimized recommendations based upon geolocation, service availability, and pricing models. This may streamline the entire repair process, reducing wait times and inconvenience.

In another instance, the system 100 may generate a presentation of a comprehensive user interface that displays vehicle health and recommended actions, and consolidates data from multiple sources, including historical repairs, active coverage policies, and service providers recommendations. This holistic display may present a user with a clear visibility into the user’s vehicle’s status and the corresponding coverage.

FIG. 1 is a diagram showing an exemplary computer system that leverages real-time vehicle telematics data (e.g., engine diagnostics data, sensor data, and/or performance data) to predict mechanical issues (e.g., engine overheating, transmission failure, brake system malfunctions, significant drop in oil pressure, etc.) to automatically trigger a coverage policy during the vehicle’s inoperability period (e.g., estimated duration a vehicle is non-operational due to mechanical issues or necessary repairs), according to certain aspects of the disclosure. FIG. 1 includes the computer system 100 that comprises a vehicle 101, sensors 103, an assessment platform 105, a database 121, external data sources 123, and a user device 125 (or mobile device, wearable, smart glasses, VR headset, AR glasses, etc.). It should be understood that other implementations of system 100 may omit one or more of the foregoing components and/or may include additional components, as the case may be.

In one instance, the vehicle 101 may represent any type of vehicle, such as smart vehicles, electric vehicles, hybrid vehicles, and/or mechanical vehicles. It is understood that the vehicle 101 may include any type of vehicles for which the user may seek a coverage policy. The system 100 may be adapted to different vehicle models, ensuring that the predictive maintenance and policy activation features work across various platforms, whether the vehicle is gas-powered, electric, or hybrid. This versatility may allow for comprehensive coverage of diverse vehicles, ensuring timely detection of mechanical problems and immediate activation of a coverage policy for necessary support services.

In one instance, the coverage policy may include a dynamically activated and managed insurance policy designed to provide financial assistance during the inoperability period of the vehicle 101. The coverage policy may include benefits such as repair cost coverage, rental vehicle provision, and towing service, depending on the severity and nature of the detected issue. The coverage may be linked to the inoperability period, ensuring that vehicle owners receive continuous support until a repair is completed. The coverage policy may be extended if repairs take longer than anticipated, resulting in providing seamless protection.

Additionally or alternatively, in one instance, the vehicle 101 may be equipped with a wide range of sensors (e.g., sensors 103) that may monitor the vehicle’s operational conditions and performance, as well as transmit the monitored data to an assessment platform 105. In one example, sensors 103 may include engine temperature sensors, oil pressure sensors, oxygen sensors for emission control, tire pressure sensors, battery management sensors, image sensors temperature sensors to monitor battery health, accelerometers, energy consumption sensors for efficient power usage, brake pad wear sensors, or fuel level sensors. It is understood that the sensors 103 may include any type of sensors that may provide data on the operational conditions of the vehicles.

The various elements of the computer system 100 may communicate with each other through a communication network. In one instance, the vehicle 101 and/or the user device 125 may include a network detection sensor for detecting wireless signals or receivers for different communications (e.g., Bluetooth, Wi-Fi, Li-Fi, near field communication (NFC), etc.) from the communication network. The communication network may support a variety of different communication protocols and communication techniques.

In one instance, the communication network may allow the vehicle 101 and/or the user device 125 (or one or more user devices) to communicate with the assessment platform 105. The communication network may include one or more networks such as a data network, a wireless network, a telephony network, or any combination thereof. It is contemplated that the data network is any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network is, for example, a cellular communication network and employs various technologies including 5G (5th Generation), 4G, 3G, 2G, Long Term Evolution (LTE), wireless fidelity (Wi-Fi), Bluetooth®, Internet Protocol (IP) data casting, satellite, mobile ad-hoc network (MANET), vehicle controller area network (CAN bus), and the like, or any combination thereof.

In one instance, the assessment platform 105 may include a platform with multiple interconnected components. The assessment platform 105 may include one or more servers, intelligent networking devices, computing devices, components, and corresponding software for processing real-time vehicle telematics data to predict mechanical issues to automatically trigger a coverage policy during the vehicle’s inoperability period.

In one instance, the assessment platform 105 may leverage advanced algorithms to process telematics data collected from the sensors (e.g., sensors 103) embedded in the vehicle 101. The telematics data may be enriched with historical data (e.g., driving conditions, maintenance history, etc.) to create a comprehensive operation profile for the vehicle 101. The platform may utilize trained machine-learning models to analyze the data, and identify patterns and anomalies that indicate potential mechanical issues. Based upon this analysis, the trained machine-learning models may predict the inoperability period of the vehicle 101 by assessing the likelihood and duration of downtime required for repairs.

Upon receiving the predicted inoperability period from the trained machine-learning models, the assessment platform 105 may automatically activate an insurance policy, ensuring that the users have immediate access to coverage for repairs, towing, rental, and any other services needed during this downtime. The assessment platform 105 may then determine recommended actions, such as scheduling urgent repairs, recommending towing services, or contacting preferred repair shops. These actions may be tailored to the specific mechanical issues identified for the vehicle 101.

In one instance, the assessment platform 105 may generate a presentation of the recommended actions through an intuitive user interface (e.g., display 127 in the user device 125) that displays relevant notifications. This interface may provide comprehensive details on the activated policy, including coverage options, and outline the recommended actions for the users. Each notification may be designed to be actionable, enabling the users to respond quickly and effectively to any mechanical issues, thereby enhancing overall vehicle safety and reliability. Such seamless integration of data processing, predictive analytics, and user interface design may facilitate the assessment platform 105 to deliver timely and relevant support to the users.

In one instance, the assessment platform 105 may comprise a data collection module 107, a data processing module 109, a machine-learning module 111, a policy activation module 113, a policy adjustment module 115, a recommendation module 117, and a user interface module 119, or any combination thereof. As used herein, terms such as “component” or “module” generally encompass hardware and/or software, e.g., that a processor or the like used to implement associated functionality. It is contemplated that the functions of these components are combined in one or more components or performed by other components of equivalent functionality.

In one instance, the data collection module 107 may collect, e.g., in real-time or near real-time, telematics data from the sensors 103 and/or historical data associated with the vehicle 101 from a plurality of data sources (e.g., database 121, external data sources 123, etc.) through various data collection techniques. In one example, the data collection module 107 may include software applications (e.g., data mining applications in Extended Meta Language (XML)) that may automatically search for and return telematics data and/or historical data associated with the vehicle 101. In another example, the data collection module 107 may use a web-crawling component to access vehicle 101, the sensors 103, the user device 125, and/or various data sources (e.g., database 121, external data sources 123, etc.) to collect the telematics data and/or historical data for the vehicle 101.

The data collection module 107 may transmit the collected data to the data processing module 109. Upon receiving the collected data, the data processing module 109 may employ advanced algorithms to clean, normalize, and preprocess the data, ensuring that it is in a suitable format for analysis. In one example, data cleansing may include removing or correcting erroneous data (e.g., redundant, incomplete, or incorrect data) to create high-quality data. The data cleansing technique also may include a data enhancement technique, where data may be made more complete by adding related information. In another example, the data normalization technique may include scaling different metrics to a common range, such as converting all sensor readings to a standardized unit of measurement, thereby allowing for accurate comparisons and analyses across different metrics. In a further example, the data preprocessing technique may include filtering out noise, handling missing values, and aggregating data points to provide a comprehensive overview of the vehicle’s performance. The data may then be subjected to various data processing methods using machine-learning and artificial intelligence algorithms.

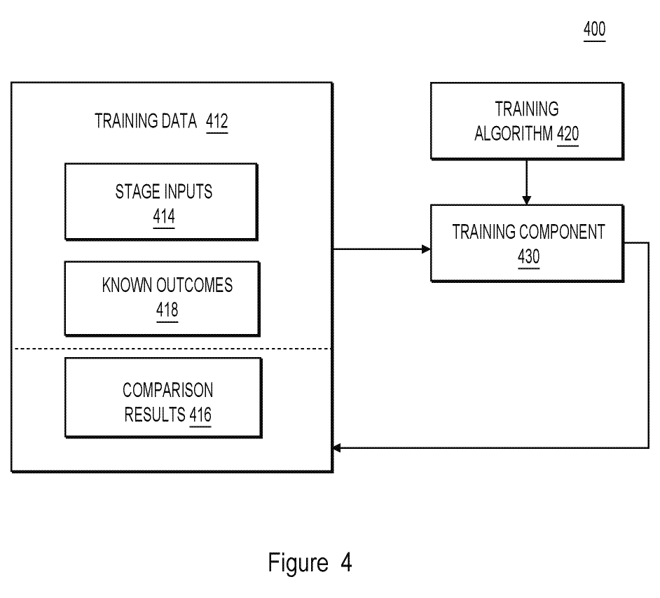

In one instance, the machine-learning module 111 may be configured for supervised machine-learning by utilizing training data (e.g., training data 412 illustrated in the training flow chart of FIG. 4). The trained model may be configured for processing telematics data and/or historical data associated with the vehicle 101 to identify patterns indicative of mechanical issues. In one example, the machine-learning module 111 may perform model training using training data (e.g., data from other modules, that contains input and correct output, to allow the model to learn over time). The training may be performed based upon the deviation of a processed result from a documented result when the inputs are fed into the machine-learning model (e.g., an algorithm measures its accuracy through the loss function, adjusting until the error has been sufficiently minimized). The trained model may utilize exponential smoothing, autoregressive integrated moving average (ARIMA), or long short-term memory (LSTM) neural networks to analyze one or more features associated with the vehicle 101 to generate predictions about the vehicle’s operational health, including the determination of the inoperability period based upon the identified mechanical issues.

In one embodiment, the machine-learning module 111 may randomize the ordering of the training data, visualize the training data to identify relevant relationships between different variables, identify data imbalances, and/or split the training data into two parts where one part is for training a model and the other part is for validating the trained model, de-duplicating, normalizing, correcting errors in the training data, and so on. The machine-learning module 111 may implement various machine-learning techniques, e.g., neural network (e.g., recurrent neural networks, graph convolutional neural networks, deep learning neural networks), decision tree learning, random forest, association rule learning, inductive programming logic, K-nearest neighbors, cox proportional hazards model, support vector machines, Bayesian models, Gradient boosted machines (GBM), LightGBM (LGBM), Xtra tree classifier, etc. Implementation of the machine-learning module 111 is discussed in detail below.

In one instance, the policy activation module 113 may automate the initiation of a coverage policy based upon the ascertained inoperability period. For example, upon receiving the predicted inoperability period, the policy activation module 113 may assess the parameters of various coverage policies to ensure alignment of the selected policy with the vehicle’s requirements. This may involve cross-referencing the policy details (e.g., coverage limits or types of services included) to the predicted mechanical issues of the vehicle 101.

Once the policy activation module 113 confirms compliance with activation criteria, it may programmatically trigger the coverage policy, thereby providing immediate financial indemnification to the users of the vehicle 101 throughout the inoperability period. This activation process may include generating structured notifications, which may detail the status of the policy, elucidate coverage provisions, and outline any recommended actions for the users of the vehicle 101. Additionally, the policy activation module 113 may interface with external service providers, such as towing, rental, and repair networks, utilizing API calls to facilitate timely and coordinated assistance aligned with the activated policy parameters.

In one instance, the policy adjustment module 115 may initiate an automated process to extend the coverage policy. In one example, the policy adjustment module 115 may incorporate a dynamic monitoring function, utilizing real-time data analytics to assess the vehicle’s repair trajectory. Should the actual repair duration exceed the initially predicted inoperability period, the policy adjustment module 115 may employ automated algorithms to extend the coverage policy. This adaptive mechanism may guarantees that the users receive sustained support throughout the repair lifecycle of the vehicle.

In addition to extending coverage, the policy adjustment module 115 may recalculate the remaining policy benefits, adjusting the terms and conditions to reflect real-time changes in service requirements. For example, if the repair complexity increases, the policy adjustment module 115 may augment the service levels or invoke secondary coverage options, such as enhanced rental car options or expedited repair services.

In one instance, the recommendation module 117 may generate recommendations based upon a real-time analysis of vehicle health, operational conditions, and/or service availability. The recommendation module 117 may continuously process inputs from multiple sources, such as telematics data, historical data, and location-based data, to provide context-aware recommendations tailored to the specific situation of the vehicle 101.

Once the machine-learning module 111 identifies the mechanical issue and/or predicts the inoperability period, the recommendation module 117 may use advanced algorithms to evaluate the best possible actions or service providers to facilitate the repair of the vehicle. For example, the recommendations may include suggesting immediate repair of the vehicle and the corresponding service providers (e.g., towing, repair, or rental service providers), all optimized based upon real-time factors. While generating the recommendations, the recommendation module 117 may factor in criteria like proximity, cost, service availability, and service providers’ reliability to generate the most optimal recommendations.

In one example, the recommendation module 117 may recommend a nearby trusted repair shop that specializes in the detected issue or may suggest a towing service based upon the vehicle type and location. In another example, the recommendation module 117 may provide a ranked list of rental car services, taking into account rental availability, user preferences, and cost-effectiveness. By leveraging the real-time data and machine-learning outputs, the recommendation module 117 may ensure that all of the suggested actions are not only relevant but are also the most efficient solutions available for the user’s immediate needs.

In one instance, the user interface module 119 may enable a presentation of a graphical user interface (GUI) in the user device 125 that may facilitate visualization of one or more recommended actions, current status of the activated coverage policy, vehicle conditions, and/or available service providers (e.g., display 127 in the user device 125). In one example, the user interface module 119 may generate a presentation of coverage policy details in the user device 125, outlining the scope of financial assistance, including repair costs, towing services, and rental car coverage. In another example, the user interface module 119 may cause a display of recommended towing or nearby repair shops, each ranked based upon factors such as proximity, cost, and reviews.

Additionally or alternatively, the user interface module 119 may cause the interfacing of information to include, at least in part, one or more annotations, audio messages, video messages, or a combination thereof. For example, the recommended actions, current status of the activated coverage policy, vehicle conditions, and/or available service providers may be displayed in a textual format (e.g., email message), a video format (e.g., a video message), or an aural format by a software application executing by the user device 125 of the user.

In one instance, the user interface module 119 may employ various application programming interfaces (APIs) or other function calls corresponding to the application on the user device 125, thus enabling the display of graphics primitives such as graphs, edges, icons, menus, buttons, data entry fields, etc. The user interface module 119 may also comprise a variety of interfaces, for example, interfaces for data input and output devices, referred to as I/O devices, storage devices, and the like. Still further, the user interface module 119 may be configured to operate in connection with augmented reality (AR) processing techniques, wherein various applications, graphic elements, and features interact.

In one instance, the database 121 may be any type of database, such as relational, hierarchical, object-oriented, and/or the like, wherein data may be organized in any suitable manner, including data tables or lookup tables. The database 121 may store content associated with the users (e.g., policyholders, drivers, vehicle owners, etc.), the vehicle 101, the assessment platform 105, and the user device 125, and may manage multiple types of information that aid in the content provisioning and sharing process. In such a manner, the database 121 may serve as the central repository for all data related to vehicle monitoring, predictive maintenance, and policy activation.

In one example, the database 121 may store telematics data (e.g., engine diagnostics, sensor readings, performance metrics, etc.) and/or historical data (e.g., past maintenance records, claims history, and repair timelines) associated with the vehicle 101. In another example, the database 121 may store service provider information, such as information corresponding to towing companies, repair shops, and rental agencies along with their proximity, availability, service ratings, and cost structures. In a further example, the database 121 may store coverage policy details, including activation times, coverage limits, and any adjustments made during the inoperability period. It is to be understood that any other suitable data may be included in the database 121.

In another instance, the database 121 may include a machine-learning based training database with a pre-defined mapping that may define a relationship between various input parameters and output parameters based upon various statistical methods. For example, the training database may include machine-learning algorithms configured to learn mappings between input parameters related to the vehicle 101. In one example, the training database may include a dataset that may include data collections that are not subject-specific, e.g., data collections based upon population-wide observations, local, regional, or super-regional observations, and the like. The training database may be routinely updated and/or supplemented based upon the machine-learning methods.

In one instance, external data sources 123 may be integrated with the assessment platform 105 to provide critical supplementary information to enhance vehicle monitoring and predictive maintenance capabilities. In one example, external data sources 123 may include weather data (e.g., real-time conditions like temperature, humidity, or road conditions that may affect vehicle performance), traffic data (e.g., congestion levels, accidents, or route disruptions), and mapping services (e.g., geo-location data for identifying the nearest service providers such as towing, repair, or rental agencies).

Additionally, the external data sources 123 may include vehicle manufacturer databases that may provide model-specific performance data (e.g., known issues, recall information, maintenance schedules, etc.). Alternatively, the external data sources 123 may include insurance databases that may provide policy-related information (e.g., coverage options, claims history). The external data sources 123 may also include regulatory and compliance databases to verify emission standards and safety certifications. It should be understood that external data sources 123 may include any other databases that provide relevant information pertaining to the vehicle 101.

The above presented modules and components of the assessment platform 105 may be implemented in hardware, firmware, software, or a combination thereof. Though depicted as a separate entity in FIG. 1, it is contemplated that the assessment platform 105 may be implemented for direct operation by the respective user device 125. As such, the assessment platform 105 may generate direct signal inputs by way of the operating system of the user device 125. In one instance, one or more of the modules 107-119 may be implemented for operation by the respective user device 125, as the assessment platform 105. The various executions presented herein contemplate any and all arrangements and models.

### EXEMPLARY INOPERABILITY PERIOD DETERMINATION AND POLICY ACTIVATION FLOWCHART

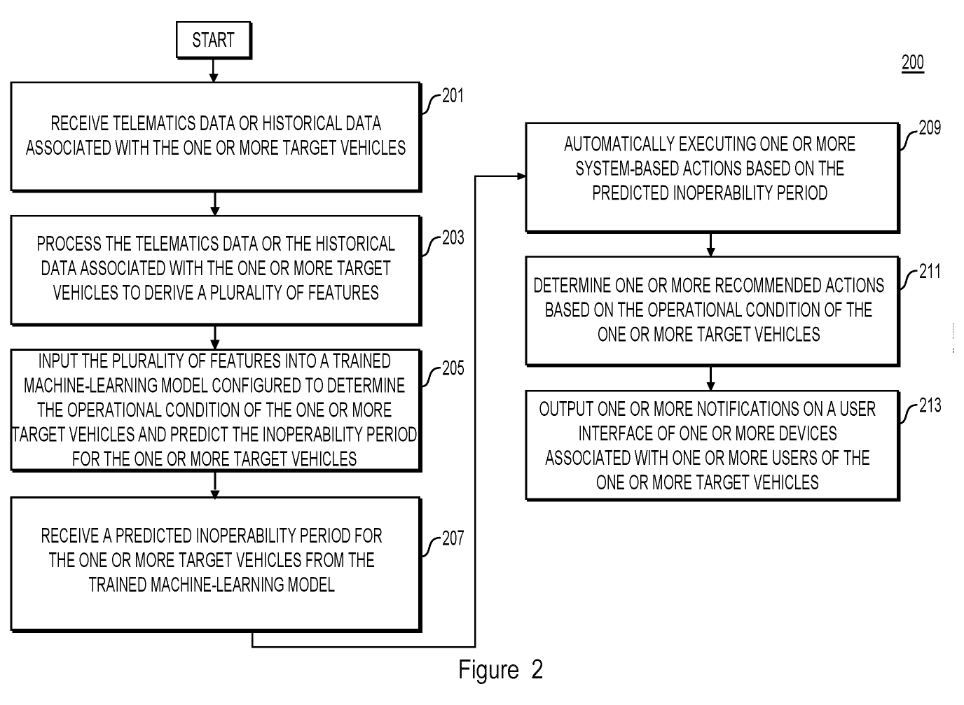

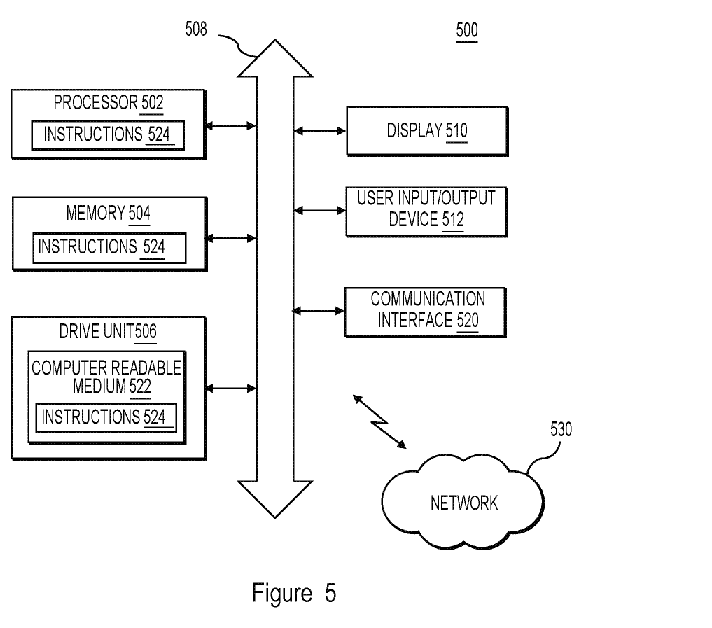

FIG. 2 is an exemplary flowchart of a computer-implemented or computer-based process for analyzing various data by utilizing a trained machine-learning model to determine an inoperability period for a vehicle and activate one or more system-based actions for the predicted inoperability period. In one instance, the assessment platform 105 and/or any of the modules 107-119 may perform one or more portions of the process 200 and are implemented using, for instance, a chip set including a processor (e.g., processor 502) and a memory (e.g., memory 504) as shown in FIG. 5. As such, the assessment platform 105 and/or any of modules 107-119 may be configured to facilitate accomplishing various parts of the process 200, as well as accomplishing embodiments of other processes described herein in conjunction with other components of the system 100. Although the process 200 is illustrated and described as a sequence of actions, operations, and/or functionality, it is contemplated that various embodiments of the process 200 may be performed in any order or combination and need not include all of the illustrated actions, operations, and/or functionality.

In block 201, the assessment platform 105 may receive telematics data or historical data associated with the target vehicles (e.g., vehicle 101). In one instance, telematics data may include engine diagnostics data (e.g., engine fault codes, engine temperature, engine revolution per minute, fuel injection status, etc.), sensor data (e.g., accelerometer data, battery data, tire pressure data, temperature data, break-pad wear data, etc.), and/or performance data (e.g., fuel efficiency, acceleration time, engine load, emission, etc.). In one instance, the historical data may include past claims data (e.g., frequency of previous breakdowns, repair costs for specific components, insurance payouts, etc.), past repair and maintenance data (e.g., oil changes, replacement of engine parts, etc.), and/or model-specific performance data (e.g., fuel efficiency under varying conditions, known issues with transmission, average lifespan of components in that model).

In block 203, the assessment platform 105 may process the telematics data or the historical data associated with the target vehicles to derive a plurality of features. In one instance, the plurality of features derived from telematics data may include average fuel efficiency, engine health, wear patterns, engine temperature trends, braking behavior patterns, etc. In one instance, the plurality of features derived from the historical data may include time since the last repair or maintenance, frequency of component failure, historical repair costs, etc. These derived features may serve as an input to the machine-learning model for predicting vehicle-related issues, such as mechanical failure, future repair needs, or downtime.

In block 205, the assessment platform 105 may input the plurality of features into a trained machine-learning model configured to determine the operational condition of the target vehicle(s) and predict a corresponding inoperability period. In one embodiment, the assessment platform 105 may receive a plurality of training datasets (e.g., vehicle-related training variables) associated with a plurality of vehicles for training the machine-learning model. The assessment platform 105 may process the plurality of training datasets to derive one or more training features for each of the plurality of vehicles. The assessment platform 105 may determine a training score indicating an operational condition for each of the plurality of vehicles based upon the plurality of training datasets. The assessment platform 105 may input the training score and one or more training features into the machine-learning model. The machine-learning model may be configured to learn one or more associations between the training score and one or more training features in order to predict the inoperability period for target vehicles.

In block 207, the assessment platform 105 may receive a predicted inoperability period for the target vehicles from the trained machine-learning model. The trained machine-learning model may identify patterns in the plurality of features that are indicative of impending failures or repairs. Once the trained machine-learning model identifies the patterns, it may predict the inoperability period that may represent the estimated duration during which the target vehicles are non-operational due to mechanical issues or necessary repairs.

In block 209, the assessment platform 105 may automatically execute system-based action(s) based upon the predicted inoperability period. In one instance, executing the system-based action(s) may include activating a coverage policy for the target vehicle 101 during the inoperability period. Activating the coverage policy may activate relevant benefits, such as repair cost coverage, rental vehicle assistance, and towing services. This automated policy activation process may ensure access to necessary resources during repairs and also minimize the inconvenience and financial impact associated with unexpected vehicle downtime. In one example, the assessment platform 105 may automatically search the database 121 for the coverage policy that corresponds to the specific user of the vehicle 101 upon receiving data related to mechanical issues or inoperability period prediction for the vehicle 101. The assessment platform 105 may utilize a unique identifier associated with the user and/or the vehicle 101 (e.g., vehicle identification number (VIN), license plate number, user account ID, etc.) to retrieve the correct coverage policy information that is specific to the user of the vehicle 101. Once the coverage policy is identified, the assessment platform 105 may activate or adjust the coverage based upon real-time conditions, ensuring the user receives the benefits and services.

In various embodiments, the assessment platform 105 may track, in real-time or near real-time, the repair completion time of the target vehicles during the predicted inoperability period. The assessment platform 105 may determine that the repair completion time exceeds the predicted inoperability period (i.e., a predefined threshold). The assessment platform 105 may then extend the coverage policy for the target vehicles to include the repair completion time. This extension may ensure that the user (e.g., vehicle owner) remains protected during the prolonged inoperability period, covering additional costs, such as extended rental vehicle usage, repair delays, or any further repairs that may be required.

In block 211, the assessment platform 105 may determine recommended actions based upon the operational condition of the target vehicles. In one example, the recommended actions may include scheduling preventive maintenance, prioritizing specific repairs, performing diagnostic testing, replacing critical components to prevent further damage, advising on driving habits, and/or recommending various services (e.g., towing, rental, or repair services).

In block 213, the assessment platform 105 may output notification(s) on a user interface of one or more devices (e.g., user device 125) associated with one or more users (e.g., driver, owner, etc.) of the target vehicles (e.g., vehicle 101). The notification(s) may include the recommended actions and an indicator corresponding to the activated coverage policy. In one example, the user interface may display options for nearby towing services, rental services, or repair services, allowing the users to select based upon real-time availability and proximity.

In one example, the assessment platform 105 may detect critical failures in the target vehicles that could lead to an immediate breakdown (e.g., engine overheating or brake system failure), and may recommend a towing service to tow the target vehicles to a nearby repair shop. In one instance, the assessment platform 105 may determine the location (e.g., real-time location) of the target vehicles using one or more sensors (e.g., location sensors). The assessment platform 105 may query a data source (e.g., database 121, external data sources 123) for towing services based upon the determined location of the target vehicles. The assessment platform 105 may identify a towing service within a predefined proximity from the location of the target vehicles based upon one or more criteria. The one or more criteria may include an estimated time of arrival, availability of towing vehicles, operational hours of the towing services, cost of towing service, rating or reviews of the towing service, weather data, and/or traffic data. The assessment platform 105 may output a display of the towing service on the user interface of the device associated with the users of the target vehicles.

In one embodiment, the assessment platform 105 may recalculate the proximity of the towing services to the location of the target vehicles based upon real-time movements of the target vehicles. The assessment platform 105 may then update the display of the towing service on the user interface of the devices based upon the recalculated proximity and the one or more criteria.

In another example, the assessment platform 105 may detect mechanical issues in the target vehicles, and may recommend a repair service. In one instance, the assessment platform 105 may determine the location (e.g., real-time location) of the target vehicles using sensors (e.g., location sensors). The assessment platform 105 may query a data source (e.g., database 121, external data sources 123) for repair services based upon the determined a location of the target vehicles. The assessment platform 105 may identify a repair service within a predefined proximity from the location of the target vehicles based upon one or more criteria. The one or more criteria may include operational hours of the repair service, cost of repair service, service ratings or reviews, and/or types of repairs offered. The assessment platform 105 may output a display of the repair service on the user interface of the device associated with the users of the target vehicles.

In a further example, the assessment platform 105 may determine that the target vehicles may be inoperable for an extended period of time, and may recommend a rental service for immediate access to an alternative vehicle. In one instance, the assessment platform 105 may determine the location (e.g., real-time location) of the target vehicles using sensors (e.g., location sensors). The assessment platform 105 may query a data source (e.g., database 121, external data sources 123) for rental services based upon the determined location of the target vehicles. The assessment platform 105 may identify a rental service within a predefined proximity from the location of the target vehicles based upon one or more criteria. The one or more criteria may include operational hours of the rental service, cost of rental service, rental service ratings or reviews, and/or rental vehicle availability. The assessment platform 105 may output a display of the repair service on the user interface of the device associated with the users of the target vehicles.

In various embodiments, the assessment platform 105 may synchronize data between the towing services, the repair services, and the rental services for a coordinated response. In one example, by aggregating real-time information, such as the vehicle’s location, severity of the issue, and/or service availability, the assessment platform 105 may compare options for the towing, repair, and rental providers. The assessment platform 105 may evaluate factors like location proximity, service costs, provider’s rating, and estimated response times to recommend the best combination of services. The assessment platform 105 may apply a selection algorithm to generate a consolidated ranking for the towing, repair, and rental services. The consolidated ranking may be displayed on the user interface of the devices.

### EXEMPLARY POLICY ACTIVATION BASED UPON TELEMATICS DATA FLOWCHART

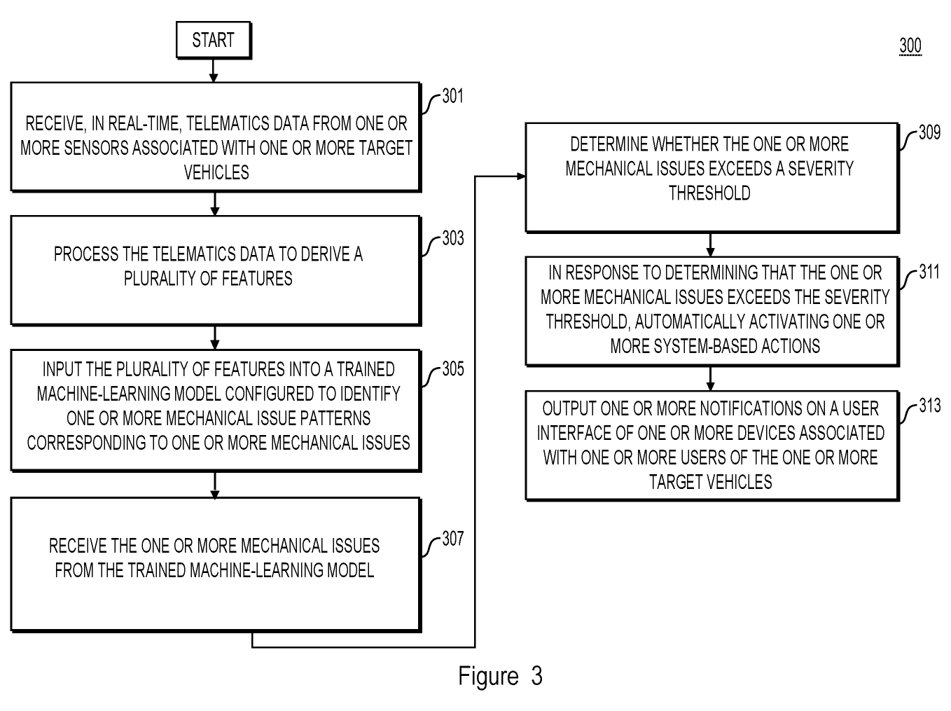

FIG. 3 is an exemplary flowchart of a computer-implemented or computer-based process for activating system-based action(s) for target vehicles based upon telematics data. In one instance, the assessment platform 105 and/or any of the modules 107-119 may perform one or more portions of the process 300 and are implemented using, for instance, a chip set including a processor (e.g., processor 502) and a memory (e.g., memory 504) as shown in FIG. 5. As such, the assessment platform 105 and/or any of modules 107-119 may be configured to facilitate accomplishing various parts of the process 300, as well as accomplishing embodiments of other processes described herein in conjunction with other components of the system 100. Although the process 300 is illustrated and described as a sequence of actions, operations, and/or functionality, it is contemplated that various embodiments of the process 300 may be performed in any order or combination and need not include all of the illustrated actions, operations, and/or functionality.

In block 301, the assessment platform 105 may receive, in real-time, telematics data from one or more sensors (e.g., sensors 103) associated with the target vehicles (e.g., vehicle 101). In one instance, telematics data may include engine diagnostics data (e.g., engine fault codes, engine temperature, engine revolution per minute, fuel injection status, etc.), sensor data (e.g., accelerometer data, battery data, tire pressure data, temperature data, break-pad wear data, etc.), and/or performance data (e.g., fuel efficiency, acceleration time, engine load, emission, etc.).

In block 303, the assessment platform 105 may process the telematics data to derive a plurality of features. In one instance, the plurality of features for the vehicle derived from telematics data may include average fuel efficiency, engine health, wear patterns, engine temperature trends, braking behavior patterns, driving behavior, etc. These derived features may serve as an input to the machine-learning model for detecting patterns indicative of mechanical issues.

In block 305, the assessment platform 105 may input the plurality of features into a trained machine-learning model configured to identify one or more mechanical issue patterns corresponding to one or more mechanical issues. In one embodiment, the assessment platform 105 may receive a plurality of training datasets (e.g., vehicle-related training variables) associated with a plurality of vehicles for training the machine-learning model. The assessment platform 105 may process the plurality of training datasets to derive one or more training features for each of the plurality of vehicles. The assessment platform 105 may determine a training score that indicates an operational condition for each of the plurality of vehicles based upon the plurality of training datasets. The assessment platform 105 may input the training score and one or more training features into the machine-learning model. The machine-learning model may be trained to learn one or more associations between the training score and one or more training features, in order to detect patterns indicative of the mechanical issues.

In block 307, the assessment platform 105 may receive mechanical issues from the trained machine-learning model. In one example, the trained machine-learning model may detect the mechanical issues (e.g., abnormal engine temperature or performance inconsistencies) based upon processing the plurality of features.

In block 309, the assessment platform 105 may determine whether the mechanical issues exceed a severity threshold. In one instance, the severity threshold may be based upon past repair and maintenance data, vehicle age, manufacturer-specific fault codes, real-time driving behavior data, or environmental conditions. In one example, the assessment platform 105 may determine that the engine temperature of the target vehicle exceeds the severity threshold indicating a potential overheating condition, which if not addressed immediately, may lead to engine failure or substantial damage to the target vehicle.

In block 311, the assessment platform 105 may automatically activate the system-based action(s) for the target vehicles upon determining that the mechanical issues exceed the severity threshold. In one instance, the system-based actions may include activating a coverage policy for the target vehicle 101. This may ensure that the users (e.g., vehicle owners) receive immediate protection and support for potential repair costs and related services. In one instance, the assessment platform 105 may verify the terms of the coverage policy and may trigger coverage options such as towing services, repair expenses, and/or rental vehicle assistance. By automating this activation, the assessment platform 105 may minimize delays in accessing critical resources, allowing the users to focus on addressing the mechanical issues without the address stress of financial uncertainty. This seamless integration enhances user experience by providing timely assistance during emergencies.

In one embodiment, the assessment platform 105 may process historical data associated with the target vehicles to estimate the remaining useful life (RUL) of the target vehicles. The assessment platform 105 may evaluate the impact of the mechanical issues on the performance metrics of the target vehicles. For example, the performance metrics may include an engine efficiency metric (e.g., fuel consumption rate in miles per gallon), an emission level metric (e.g., carbon dioxide (CO₂) emission in grams per kilogram (g/km), and/or a safety system functionality metric (e.g., effectiveness of anti-lock braking system (ABS) measure by response time in emergency braking scenarios). The assessment platform 105 may adjust dynamic parameters in the coverage policy based upon the evaluation of the impact of the mechanical issues. In one example, the adjustment may include recalculating coverage limit parameters, deductible parameters, or co-payment parameters.

In block 313, the assessment platform 105 may output one or more notifications on a user interface of one or more devices (e.g., user device 125) associated with one or more users (e.g., driver, owner, etc.) of the target vehicles. The notifications may include the system-based actions (e.g., activated coverage policy) and the recommended actions. In one example, the coverage policy may outline specific benefits available to the users, such as coverage for repair costs, towing services, and rental vehicle expenses. In one example, the recommended actions may include parking the target vehicles on a level surface, scheduling an appointment for towing, repair, or rental services, and/or monitoring specific vehicle performance metrics for a potential degradation (e.g., patterns or anomalies that suggest a deterioration in vehicle condition).

### EXEMPLARY MACHINE-LEARNING TECHNIQUES

One or more implementations disclosed herein include and/or may be implemented using a machine-learning model. For example, one or more of the modules of assessment platform 105 may be implemented using a machine-learning model and/or may be used to train the machine-learning model. A given machine-learning model may be trained using the data flow 400 of FIG. 4. Training data 412 may include one or more of stage inputs 414 and known outcomes 418 related to the machine-learning model to be trained. The stage inputs 414 may be from any applicable source including text, visual representations, data, values, comparisons, stage outputs, e.g., one or more outputs from one or more actions or operations from FIGS. 2 and 3. The known outcomes 418 may be included for the machine-learning models generated based upon supervised or semi-supervised training. An unsupervised machine-learning model may not be trained using known outcomes 418. Known outcomes 418 may include known or desired outputs for future inputs similar to or in the same category as stage inputs 414 that do not have corresponding known outputs.

The training data 412 and a training algorithm 420, e.g., one or more of the modules implemented using the machine-learning model and/or may be used to train the machine-learning model, may be provided to a training component 430 that may apply the training data 412 to the training algorithm 420 to generate the machine-learning model. According to an implementation, the training component 430 may be provided comparison results 416 that compare a previous output of the corresponding machine-learning model to apply the previous result to re-train the machine-learning model. The comparison results 416 may be used by training component 430 to update the corresponding machine-learning model. The training algorithm 420 may utilize machine-learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, classifiers such as K-Nearest Neighbors, and/or discriminative models such as Decision Forests and maximum margin methods, models specifically discussed in the present disclosure, or the like.

The machine-learning model used herein may be trained and/or used by adjusting one or more weights and/or one or more layers of the machine-learning model. For example, during training, a given weight may be adjusted (e.g., increased, decreased, removed) based upon training data or input data. Similarly, a layer may be updated, added, or removed based upon training data/and or input data. The resulting outputs may be adjusted based upon the adjusted weights and/or layers.

In general, any process or operation discussed in this disclosure is understood to be computer-implementable, such as the processes illustrated in FIGS. 2 and 3 may be performed by one or more processors of a computer system as described herein. A process or process action or operation performed by one or more processors may also be referred to as an operation. The one or more processors may be configured to perform such processes by having access to instructions (e.g., software or computer-readable code) that, when executed by one or more processors, cause the one or more processors to perform the processes. The instructions may be stored in a memory of the computer system. A processor may be a central processing unit (CPU), a graphics processing unit (GPU), or any suitable type of processing unit.

A computer system, such as a system or device implementing a process or operation in the examples above, may include one or more computing devices. One or more processors of a computer system may be included in a single computing device or distributed among a plurality of computing devices. One or more processors of a computer system may be connected to a data storage device. A memory of the computer system may include the respective memory of each computing device of the plurality of computing devices.

### EXEMPLARY COMPUTING ENVIRONMENT

FIG. 5 illustrates an implementation of a computer system that may execute techniques presented herein. The computer system 500 can include a set of instructions that can be executed to cause the computer system 500 to perform any one or more of the methods or computer based functions disclosed herein. The computer system 500 may operate as a standalone device or may be connected, e.g., using a network, to other computer systems or peripheral devices.

Unless specifically stated otherwise, as apparent from the following discussions, it is appreciated that throughout the specification, discussions utilizing terms such as “processing,” “computing,” “calculating,” “determining”, “analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer,” a “computing machine,” a “computing platform,” a “computing device,” or a “server” may include one or more processors.

In a networked deployment, the computer system 500 may operate in the capacity of a server or as a client user computer in a server-client user network environment, or as a peer computer system in a peer-to-peer (or distributed) network environment. The computer system 500 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the computer system 500 may be implemented using electronic devices that provide voice, video, or data communication. Further, while the computer system 500 is illustrated as a single system, the term “system” shall also be taken to include any collection of systems or sub-systems that individually or jointly execute a set, or multiple sets, of instructions to perform one or more computer functions.

As illustrated in FIG. 5, the computer system 500 may include a processor 502, e.g., a central processing unit (CPU), a graphics processing unit (GPU), or both. The processor 502 may be a component in a variety of systems. For example, the processor 502 may be part of a standard personal computer or a workstation. The processor 502 may be one or more processors, digital signal processors, application specific integrated circuits, field programmable gate arrays, servers, networks, digital circuits, analog circuits, combinations thereof, or other now known or later developed devices for analyzing and processing data. The processor 502 may implement a software program, such as code generated manually (i.e.,programmed).

The computer system 500 may include a memory 504 that can communicate via bus 508. The memory 504 may be a main memory, a static memory, or a dynamic memory. The memory 504 may include, but is not limited to, computer readable storage media such as various types of volatile and non-volatile storage media, including but not limited to, random access memory, read-only memory, programmable read-only memory, electrically programmable read-only memory, electrically erasable read-only memory, flash memory, magnetic tape or disk, optical media and the like. In one implementation, the memory 504 includes a cache or random-access memory for the processor 502. In alternative implementations, the memory 504 is separate from the processor 502, such as a cache memory of a processor, the system memory, or other memory. The memory 504 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 504 is operable to store instructions executable by the processor 502. The functions, acts or tasks illustrated in the figures or described herein may be performed by the processor 502 executing the instructions stored in the memory 504. The functions, acts, or tasks are independent of the particular type of instruction set, storage media, processor or processing strategy and may be performed by software, hardware, integrated circuits, firmware, micro-code and the like, operating alone or in combination. Likewise, processing strategies may include multiprocessing, multitasking, parallel processing, and the like.

As shown, the computer system 500 may further include a display 510, such as a liquid crystal display (LCD), an organic light emitting diode (OLED), a flat panel display, a solid-state display, a cathode ray tube (CRT), a projector, a printer or other now known or later developed display device for outputting determined information. The display 510 may act as an interface for the user to see the functioning of the processor 502, or specifically as an interface with the software stored in the memory 504 or in the drive unit 506.

Additionally or alternatively, the computer system 500 may include an input/output device 512 configured to allow a user to interact with any of the components of the computer system 500. The input/output device 512 may be a number pad, a keyboard, or a cursor control device, such as a mouse, or a joystick, touch screen display, remote control, or any other device operative to interact with the computer system 500.

The computer system 500 may also or alternatively include drive unit 506 implemented as a disk or optical drive. The drive unit 506 may include a computer-readable medium 522 in which one or more sets of instructions 524, e.g., software, can be embedded. Further, instructions 524 may embody one or more of the methods or logic as described herein. The instructions 524 may reside completely or partially within the memory 504 and/or within the processor 502 during execution by the computer system 500. The memory 504 and the processor 502 also may include computer-readable media as discussed above.

In some systems, computer-readable medium 522 includes the set of instructions 524 or receives and executes the set of instructions 524 responsive to a propagated signal so that a device connected to network 530 can communicate voice, video, audio, images, or any other data over the network 530. Further, the set of instructions 524 may be transmitted or received over the network 530 via communication port or interface 520, and/or using bus 508. The communication port or interface 520 may be a part of the processor 502 or may be a separate component. The communication port or interface 520 may be created in software or may be a physical connection in hardware. The communication port or interface 520 may be configured to connect with a network 530, external media, the display 510, or any other components in computer system 500, or combinations thereof. The connection with the network 530 may be a physical connection, such as a wired Ethernet connection or may be established wirelessly as discussed below. Likewise, the additional connections with other components of the computer system 500 may be physical connections or may be established wirelessly. The network 530 may alternatively be directly connected to the bus 508.

While the computer-readable medium 522 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that causes a computer system to perform any one or more of the methods or operations disclosed herein. The computer-readable medium 522 may be non-transitory, and may be tangible.

The computer-readable medium 522 can include a solid-state memory such as a memory card or other package that houses one or more non-volatile read-only memories. The computer-readable medium 522 can be a random-access memory or other volatile re-writable memory. Additionally or alternatively, the computer-readable medium 522 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

Computer system 500 may be connected to network 530. The network 530 may define one or more networks including wired or wireless networks. The wireless network may be a cellular telephone network, an 802.10, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 530 may include wide area networks (WAN), such as the Internet, local area networks (LAN), campus area networks, metropolitan area networks, a direct connection such as through a Universal Serial Bus (USB) port, or any other networks that may allow for data communication.

The network 530 may be configured to couple one computing device to another computing device to enable communication of data between the devices. The network 530 may generally be enabled to employ any form of machine-readable media for communicating information from one device to another. The network 530 may include communication methods by which information may travel between computing devices.

The network 530 may be divided into sub-networks. The sub-networks may allow access to all of the other components connected thereto or the sub-networks may restrict access between the components. The network 530 may be regarded as a public or private network connection and may include, for example, a virtual private network or an encryption or other security mechanism employed over the public Internet, or the like.

### Exemplary Embodiments

A computer-implemented method for monitoring an operational condition of one or more target vehicles for predicting an inoperability period to activate a coverage policy may be provided. The computer-implemented method may be performed by one or more local or remote processors of a computing system in communication with one or more local or remote data sources. The computer-implemented method may include (1) receiving, by one or more processors, telematics data or historical data associated with the one or more target vehicles; (2) processing, by the one or more processors, the telematics data or the historical data associated with the one or more target vehicles to derive a plurality of features; (3) inputting, by the one or more processors, the plurality of features into a trained machine-learning model configured to determine the operational condition of the one or more target vehicles and predict the inoperability period for the one or more target vehicles; (4) receiving, by the one or more processors, a predicted inoperability period for the one or more target vehicles from the trained machine-learning model; (5) activating, by the one or more processors, the coverage policy for the one or more target vehicles during the predicted inoperability period; (6) determining, by the one or more processors, one or more recommended actions based upon the operational condition of the one or more target vehicles; and/or (7) outputting, by the one or more processors, one or more notifications on a user interface of one or more devices associated with one or more users of the one or more target vehicles. The one or more notifications may include the one or more recommended actions and an indicator corresponding to the activated coverage policy. The method may include additional, less, or alternate functionality, including that discussed elsewhere herein.

In certain aspects, telematics data may include one or more of (i) engine diagnostics data, (ii) sensor data, or (ii) performance data. The historical data may include one or more of (i) past claims data, (ii) past repair and maintenance data, or (iii) model-specific performance data.

In some embodiments, the voice bots or chatbots may be configured to utilize AI and/or ML techniques, such as for input or output devices. For instance, a voice bot or chatbot may be a ChatGPT chatbot, an InstructGPT bot, a Codex bot, or a Google Bard bot. The voice bot or chatbot may employ supervised or unsupervised ML techniques, which may be followed by, and/or used in conjunction with, reinforced or reinforcement learning techniques. The voice bot or chatbot may employ the techniques utilized for ChatGPT, InstructGPT bot, Codex bot, or Google Bard bot.

In certain aspects, training the machine-learning model may include (i) receiving, by the one or more processors, a plurality of training datasets associated with a plurality of vehicles, wherein the plurality of training datasets includes vehicle-related training variables; (ii) processing, by the one or more processors, the plurality of training datasets to derive one or more training features for each of the plurality of vehicles; (iii) determining, by the one or more processors, a training score indicating an operational condition for each of the plurality of vehicles based upon the plurality of training datasets; and (iv) inputting, by the one or more processors, the training score and the one or more training features for each of the plurality of vehicles into the trained machine-learning model. The trained machine-learning model may be configured to learn one or more associations between the training score and the one or more training features to predict the inoperability period.

In certain embodiments, providing towing services to one or more target vehicles may include (i) determining, by the one or more processors, using one or more sensors, a location of at least one of the one or more target vehicles; (ii) querying, by the one or more processors, a data source for one or more towing services based upon the location of the at least one of the one or more target vehicles; (iii) identifying, by the one or more processors, at least one towing service within a predefined proximity from the location of the at least one of the one or more target vehicles based upon one or more criteria; and/or (iv) outputting, by the one or more processors, a display of the at least one towing service on the user interface of the one or more devices associated with the one or more users of the one or more target vehicles.

For instance, the one or more criteria may include one or more of (i) an estimated time of arrival, (ii) an availability of towing vehicles, (iii) one or more operational hours of the one or more towing services, (iv) a cost of towing service, (v) one or more rating or reviews of the towing service, (vi) weather data, and/or (vii) traffic data.

Additionally or alternatively, providing the towing services to the one or more target vehicles may further include (i) recalculating, by the one or more processors, a proximity of the one or more towing services to the location of the at least one of the one or more target vehicles based upon one or more real-time movements of the one or more target vehicles; and (ii) updating, by the one or more processors, the display of the at least one towing service on the user interface of the one or more devices based upon the recalculated proximity and the one or more criteria.

In certain embodiments, providing repair services to the one or more target vehicles may further include (i) querying, by the one or more processors, the data source for one or more repair services based upon the location of the at least one of the one or more target vehicles; (ii) identifying, by the one or more processors, at least one repair service within the predefined proximity from the location of the at least one of the one or more target vehicles based upon the one or more criteria; and/or (iii) outputting, by the one or more processors, a display of the at least one repair service on the user interface of the one or more devices associated with the one or more users of the one or more target vehicles.

For instance, the one or more criteria may include one or more (i) operational hours of the one or more repair services, (ii) a cost of repair service, (iii) one or more service ratings or reviews, and/or (iv) one or more types of repairs offered.

In certain embodiments, providing rental services to one or more target vehicles may include (i) querying, by the one or more processors, the data source for one or more rental services based upon the location of the at least one of the one or more target vehicles; (ii) identifying, by the one or more processors, at least one rental service within the predefined proximity from the location of the at least one of the one or more target vehicles based upon the one or more criteria; and/or (iii) outputting, by the one or more processors, a display of the at least one rental service on the user interface of the one or more devices associated with the one or more users of the one or more target vehicles.

For instance, the one or more criteria may include one or more (i) operational hours of the one or more rental services, (ii) a cost of rental service, (iii) one or more rental service ratings or reviews, and/or (iv) rental vehicle availability.

In some embodiments, generating a consolidated rankings of one or more services may include (i) synchronizing, by the one or more processors, data between the one or more towing services, the one or more repair services, and the one or more rental services; (ii) applying, by the one or more processors, a selection algorithm to generate a consolidated ranking for the one or more towing services, the one or more repair services, and the one or more rental services; and/or (iii) outputting, by the one or more processors, the consolidated ranking on the user interface of the one or more devices.

In certain embodiments, extending the coverage policy for the one or more target vehicles may include (i) tracking, by the one or more processors, a repair completion time of the one or more target vehicles during the predicted inoperability period; (ii) determining, by the one or more processors, that the repair completion time for the repair of the one or more target vehicles exceeds the predicted inoperability period; and/or (iii) extending, by the one or more processors, the coverage policy for the one or more target vehicles to include the repair completion time of the one or more target vehicles.

A computer-implemented method for activating a coverage policy for one or more target vehicles based upon telematics data may be provided. The computer-implemented method may be performed by one or more processors of a computing system in communication with one or more data sources. The computer-implemented method may include (1) receiving, in real-time by the one or more processors, the telematics data from one or more sensors associated with the one or more target vehicles; (2) processing, by the one or more processors, the telematics data to derive a plurality of features; (3) inputting, by the one or more processors, the plurality of features into a trained machine-learning model configured to identify one or more mechanical issue patterns corresponding to one or more mechanical issues; (4) receiving, by the one or more processors, the one or more mechanical issues from the trained machine-learning model; (5) determining, by the one or more processors, whether the one or more mechanical issues exceeds a severity threshold; (6) in response to determining that the one or more mechanical issues exceeds the severity threshold, activating, by the one or more processors, the coverage policy for the one or more target vehicles; and/or (7) outputting, by the one or more processors, one or more notifications on a user interface of one or more devices associated with one or more users of the one or more target vehicles. The method may include additional, less, or alternate functionality, including that discussed elsewhere herein.

For instance, the one or more notifications may include (i) the coverage policy and (ii) one or more recommended actions. For instance, the telematics data may include one or more of (i) engine diagnostics data, (ii) sensor data, or (iii) performance data.

In certain aspects, training the machine-learning model may include (i) receiving, by the one or more processors, a plurality of training datasets associated with a plurality of vehicles, wherein the plurality of training datasets includes vehicle-related training variables; (ii) processing, by the one or more processors, the plurality of training datasets to derive one or more training features for each of the plurality of vehicles; (iii) determining, by the one or more processors, a training score indicating an operational condition for each of the plurality of vehicles based upon the plurality of training datasets; and/or (iv) inputting, by the one or more processors, the training score and the one or more training features for each of the plurality of vehicles into the trained machine-learning model. The trained machine-learning model may be configured to learn one or more associations between the training score and the one or more training features to detect the one or more patterns indicative of the one or more mechanical issues.

In certain embodiments, activating the coverage policy may include (i) processing, by the one or more processors, historical data associated with the one or more target vehicles to estimate a remaining useful life of the one or more target vehicles; (ii) evaluating, by the one or more processors, an impact of the one or more mechanical issues on one or more performance metrics of the one or more target vehicles; and/or (iii) adjusting, by the one or more processors, one or more dynamic parameters in the coverage policy based upon the evaluation.

For instance, the one or more performance metrics may include (i) an engine efficiency metric, (ii) an emission level metric, or (iii) a safety system functionality metric. For instance, the adjustment of the one or more dynamic parameters may include (i) recalculating one or more coverage limit parameters, (ii) one or more deductible parameters, and/or (iii) one or more co-payment parameters.

In certain aspects, the severity threshold may be based upon one or more of (i) past repair and maintenance data, (ii) a vehicle age, (iii) one or more manufacturer-specific fault codes, (iv) real-time driving behavior data, and/or (v) one or more environmental conditions.

In certain embodiments, the one or more recommended actions may include (i) parking at least one target vehicle on a level surface, (ii) scheduling an appointment for a towing service, a repair service, or a rental service, and/or (iii) monitoring one or more specific vehicle performance metrics for a potential degradation.

A system for monitoring an operational condition of one or more target vehicles for predicting an inoperability period to activate a coverage policy may be provided. The system may include one or more processors of a computing system, and at least one non-transitory computer readable medium storing instructions which, when executed by the one or more processors, cause the one or more processors to perform operations. The system may perform operations including (1) receiving telematics data or historical data associated with the one or more target vehicles; (2) processing the telematics data or the historical data associated with the one or more target vehicles to derive a plurality of features; (3) inputting the plurality of features into a trained machine-learning model configured to determine the operational condition of the one or more target vehicles and predict the inoperability period for the one or more target vehicles; (4) receiving a predicted inoperability period for the one or more target vehicles from the trained machine-learning model; (5) activating the coverage policy for the one or more target vehicles during the predicted inoperability period; (6) determining one or more recommended actions based upon the operational condition of the one or more target vehicles; and/or (7) outputting one or more notifications on a user interface of one or more devices associated with one or more users of the one or more target vehicles. The method may include additional, less, or alternate functionality, including that discussed elsewhere herein.

For instance, the telematics data may include one or more of (i) engine diagnostics data, (ii) sensor data, or (iii) performance data. For instance, the historical data may include one or more of (i) past claims data, (ii) past repair and maintenance data, and/or (iii) model-specific performance data. For instance, the one or more notifications may include (i) the one or more recommended actions and (ii) an indicator corresponding to the activated coverage policy.

In certain aspects, training the machine-learning model may include (i) receiving a plurality of training datasets associated with a plurality of vehicles, wherein the plurality of training datasets includes vehicle-related training variables; (ii) processing the plurality of training datasets to derive one or more training features for each of the plurality of vehicles; (iii) determining a training score indicating an operational condition for each of the plurality of vehicles based upon the plurality of training datasets; and/or (iv) inputting the training score and the one or more training features for each of the plurality of vehicles into the trained machine-learning model. The trained machine-learning model may be configured to learn one or more associations between the training score and the one or more training features to predict the inoperability period.

In certain embodiments, providing towing services to one or more target vehicles may include (i) determining, using one or more sensors, a location of at least one of the one or more target vehicles; (ii) querying a data source for one or more towing services based upon the location of the at least one of the one or more target vehicles; (iii) identifying at least one towing service within a predefined proximity from the location of the at least one of the one or more target vehicles based upon one or more criteria; and/or (iv) outputting a display of the at least one towing service on the user interface of the one or more devices associated with the one or more users of the one or more target vehicles.

### ADDITIONAL CONSIDERATIONS

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the actions, operations, and/or functionality of computer-implemented methods discussed are performed in one embodiment by an appropriate processor (or processors) of a processing (i.e.,computer) system executing instructions (computer-readable code) stored in storage. It will also be understood that the disclosure is not limited to any particular implementation or programming technique and that the disclosure may be implemented using any appropriate techniques for implementing the functionality described herein. The disclosure is not limited to any particular programming language or operating system.

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘_______’ is hereby defined to mean…” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Finally, unless a claim element is defined by expressly reciting the word “means” and a function without the recital of any structure, it is not intended that the scope of any claim element be interpreted based upon the application of 35 U.S.C. § 112(f).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in exemplary configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations). A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some exemplary embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of geographic locations.

Unless specifically stated otherwise, discussions herein using words such as processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Upon reading this disclosure, those of skill in the art will appreciate still additional alternative structural and functional designs for the approaches described herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited and modifications may be made without departing from the invention. The scope of the invention is defined by the appended claims, and all devices that come within the meaning of the claims, either literally or by equivalence, are intended to be embraced therein.

It is therefore intended that the foregoing detailed description be regarded as illustrative rather than limiting, and that it be understood that it is the following claims, including all equivalents, that are intended to define the spirit and scope of this invention.

What is claimed is:

1. A computer-implemented method for monitoring an operational condition of one or more target vehicles for predicting an inoperability period to activate one or more system-based actions, the computer-implemented method performed by one or more processors of a computing system in communication with one or more data sources, the computer-implemented method comprising:
receiving, by the one or more processors, telematics data or historical data associated with the one or more target vehicles;
processing, by the one or more processors, the telematics data or the historical data associated with the one or more target vehicles to derive a plurality of features;
inputting, by the one or more processors, the plurality of features into a trained machine-learning model configured to determine the operational condition of the one or more target vehicles and predict the inoperability period for the one or more target vehicles;
receiving, by the one or more processors, a predicted inoperability period for the one or more target vehicles from the trained machine-learning model;
automatically executing, by the one or more processors, the one or more system-based actions based upon the predicted inoperability period;
determining, by the one or more processors, one or more recommended actions based upon the operational condition of the one or more target vehicles; and
outputting, by the one or more processors, one or more notifications on a user interface of one or more devices associated with one or more users of the one or more target vehicles, wherein the one or more notifications includes the one or more recommended actions and an indicator corresponding to the one or more system-based actions.

2. The computer-implemented method of claim 1, wherein the telematics data includes one or more of engine diagnostics data, sensor data, or performance data.

3. The computer-implemented method of claim 1, wherein the historical data includes one or more of past claims data, past repair and maintenance data, or model-specific performance data.

4. The computer-implemented method of claim 1, wherein training the machine-learning model comprises:
receiving, by the one or more processors, a plurality of training datasets associated with a plurality of vehicles, wherein the plurality of training datasets includes vehicle-related training variables;
processing, by the one or more processors, the plurality of training datasets to derive one or more training features for each of the plurality of vehicles;
determining, by the one or more processors, a training score indicating an operational condition for each of the plurality of vehicles based upon the plurality of training datasets; and
inputting, by the one or more processors, the training score and the one or more training features for each of the plurality of vehicles into the trained machine-learning model, wherein the trained machine-learning model is configured to learn one or more associations between the training score and the one or more training features to predict the inoperability period.

5. The computer-implemented method of claim 1, further comprising:
determining, by the one or more processors, using one or more sensors, a location of at least one of the one or more target vehicles;
querying, by the one or more processors, a data source for one or more towing services based upon the location of the at least one of the one or more target vehicles;
identifying, by the one or more processors, at least one towing service within a predefined proximity from the location of the at least one of the one or more target vehicles based upon one or more criteria; and
outputting, by the one or more processors, a display of the at least one towing service on the user interface of the one or more devices associated with the one or more users of the one or more target vehicles.

6. The computer-implemented method of claim 5, wherein the one or more criteria includes one or more of an estimated time of arrival, an availability of towing vehicles, one or more operational hours of the one or more towing services, a cost of towing service, one or more rating or reviews of the towing service, weather data, and/or traffic data.

7. The computer-implemented method of claim 5, further comprising:
recalculating, by the one or more processors, a proximity of the one or more towing services to the location of the at least one of the one or more target vehicles based upon one or more real-time movements of the one or more target vehicles; and
updating, by the one or more processors, the display of the at least one towing service on the user interface of the one or more devices based upon the recalculated proximity and the one or more criteria.

8. The computer-implemented method of claim 5, further comprising:
querying, by the one or more processors, the data source for one or more repair services based upon the location of the at least one of the one or more target vehicles;
identifying, by the one or more processors, at least one repair service within the predefined proximity from the location of the at least one of the one or more target vehicles based upon the one or more criteria, wherein the one or more criteria includes one or more operational hours of the one or more repair services, a cost of repair service, one or more service ratings or reviews, and/or one or more types of repairs offered; and
outputting, by the one or more processors, a display of the at least one repair service on the user interface of the one or more devices associated with the one or more users of the one or more target vehicles.

9. The computer-implemented method of claim 8, further comprising:
querying, by the one or more processors, the data source for one or more rental services based upon the location of the at least one of the one or more target vehicles;
identifying, by the one or more processors, at least one rental service within the predefined proximity from the location of the at least one of the one or more target vehicles based upon the one or more criteria, wherein the one or more criteria includes one or more operational hours of the one or more rental services, a cost of rental service, one or more rental service ratings or reviews, and/or rental vehicle availability; and
outputting, by the one or more processors, a display of the at least one rental service on the user interface of the one or more devices associated with the one or more users of the one or more target vehicles.

10. The computer-implemented method of claim 9, further comprising:
synchronizing, by the one or more processors, data between the one or more towing services, the one or more repair services, and the one or more rental services;
applying, by the one or more processors, a selection algorithm to generate a consolidated ranking for the one or more towing services, the one or more repair services, and the one or more rental services; and
outputting, by the one or more processors, the consolidated ranking on the user interface of the one or more devices.

11. The computer-implemented method of claim 1, wherein the one or more system-based actions include activating a coverage policy for the one or more target vehicles during the inoperability period, and wherein activating the coverage policy comprises:
tracking, by the one or more processors, a repair completion time of the one or more target vehicles during the predicted inoperability period;
determining, by the one or more processors, that the repair completion time for the repair of the one or more target vehicles exceeds the predicted inoperability period; and
extending, by the one or more processors, the coverage policy for the one or more target vehicles to include the repair completion time of the one or more target vehicles.

12. A computer-implemented method for activating one or more system-based actions for one or more target vehicles based upon telematics data, the computer-implemented method performed by one or more processors of a computing system in communication with one or more data sources, the computer-implemented method comprising:
receiving, in real-time by the one or more processors, the telematics data from one or more sensors associated with the one or more target vehicles;
processing, by the one or more processors, the telematics data to derive a plurality of features;
inputting, by the one or more processors, the plurality of features into a trained machine-learning model configured to identify one or more mechanical issue patterns corresponding to one or more mechanical issues;
receiving, by the one or more processors, the one or more mechanical issues from the trained machine-learning model;
determining, by the one or more processors, whether the one or more mechanical issues exceeds a severity threshold;
in response to determining that the one or more mechanical issues exceeds the severity threshold, automatically activating, by the one or more processors, the one or more system-based actions for the one or more target vehicles; and
outputting, by the one or more processors, one or more notifications on a user interface of one or more devices associated with one or more users of the one or more target vehicles, wherein the one or more notifications include the one or more system-based actions and one or more recommended actions.

13. The computer-implemented method of claim 12, wherein the telematics data includes one or more of engine diagnostics data, sensor data, or performance data.

14. The computer-implemented method of claim 12, wherein training the machine-learning model comprises:
receiving, by the one or more processors, a plurality of training datasets associated with a plurality of vehicles, wherein the plurality of training datasets includes vehicle-related training variables;
processing, by the one or more processors, the plurality of training datasets to derive one or more training features for each of the plurality of vehicles;
determining, by the one or more processors, a training score indicating an operational condition for each of the plurality of vehicles based upon the plurality of training datasets; and
inputting, by the one or more processors, the training score and the one or more training features for each of the plurality of vehicles into the trained machine-learning model, wherein the trained machine-learning model is configured to learn one or more associations between the training score and the one or more training features to detect the one or more patterns indicative of the one or more mechanical issues.

15. The computer-implemented method of claim 12, wherein the one or more system-based actions include activating a coverage policy for the one or more target vehicles during an inoperability period, and wherein activating the coverage policy comprises:
processing, by the one or more processors, historical data associated with the one or more target vehicles to estimate a remaining useful life of the one or more target vehicles;
evaluating, by the one or more processors, an impact of the one or more mechanical issues on one or more performance metrics of the one or more target vehicles, wherein the one or more performance metrics include an engine efficiency metric, an emission level metric, or a safety system functionality metric; and
adjusting, by the one or more processors, one or more dynamic parameters in the coverage policy based upon the evaluation, wherein the adjustment of the one or more dynamic parameters includes recalculating one or more coverage limit parameters, one or more deductible parameters, or one or more co-payment parameters.

16. The computer-implemented method of claim 12, wherein the severity threshold is based upon one or more of past repair and maintenance data, a vehicle age, one or more manufacturer-specific fault codes, real-time driving behavior data, or one or more environmental conditions.

17. The computer-implemented method of claim 12, wherein the one or more recommended actions include parking at least one target vehicle on a level surface, scheduling an appointment for a towing service, a repair service, or a rental service, and/or monitoring one or more specific vehicle performance metrics for a potential degradation.

18. A system for monitoring an operational condition of one or more target vehicles for predicting an inoperability period to activate one or more system-based actions, comprising:
one or more processors of a computing system; and
at least one non-transitory computer readable medium storing instructions which, when executed by the one or more processors, cause the one or more processors to perform operations comprising:
receiving telematics data or historical data associated with the one or more target vehicles, wherein the telematics data includes one or more of engine diagnostics data, sensor data, or performance data, and wherein the historical data includes one or more of past claims data, past repair and maintenance data, or model-specific performance data;
processing the telematics data or the historical data associated with the one or more target vehicles to derive a plurality of features;
inputting the plurality of features into a trained machine-learning model configured to determine the operational condition of the one or more target vehicles and predict the inoperability period for the one or more target vehicles;
receiving a predicted inoperability period for the one or more target vehicles from the trained machine-learning model;
automatically executing the one or more system-based actions based upon the predicted inoperability period;
determining one or more recommended actions based upon the operational condition of the one or more target vehicles; and
outputting one or more notifications on a user interface of one or more devices associated with one or more users of the one or more target vehicles, wherein the one or more notifications includes the one or more recommended actions and an indicator corresponding to the one or more system-based actions.

19. The system of claim 18, wherein training the machine-learning model comprises:
receiving a plurality of training datasets associated with a plurality of vehicles, wherein the plurality of training datasets includes vehicle-related training variables;
processing the plurality of training datasets to derive one or more training features for each of the plurality of vehicles;
determining a training score indicating an operational condition for each of the plurality of vehicles based upon the plurality of training datasets; and
inputting the training score and the one or more training features for each of the plurality of vehicles into the trained machine-learning model, wherein the trained machine-learning model is configured to learn one or more associations between the training score and the one or more training features to predict the inoperability period.

20. The system of claim 19, further comprising:
determining, using one or more sensors, a location of at least one of the one or more target vehicles;
querying a data source for one or more towing services based upon the location of the at least one of the one or more target vehicles;
identifying at least one towing service within a predefined proximity from the location of the at least one of the one or more target vehicles based upon one or more criteria; and
outputting a display of the at least one towing service on the user interface of the one or more devices associated with the one or more users of the one or more target vehicles.
